(19) United States
(12) Patent Application Publication
(10) Pub. No.: US 2016/0023188 A1
(43) Pub. Date: Jan. 28, 2016

(54) Pseudo-brookite Compositions as Active Zero-PGM Catalysts for Diesel Oxidation Applications

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: Clean Diesel Technologies, Inc., Oxnard, CA (US)

(21) Appl. No.: 14/873,020

(22) Filed: Oct. 1, 2015

Related U.S. Application Data
(63) Continuation-in-part of application No. 13/911,986, filed on Jun. 6, 2013.

(51) Int. Cl. B01J 23/34; B01J 37/00; B01J 37/08; C01G 45/12; B01J 37/04

(52) U.S. Cl. CPC B01J 23/34; C01G 45/1285; B01J 37/04; B01J 37/08; B01J 37/0036; C01P 2002/34

(57) ABSTRACT

YMn₂O₅ pseudo-brookite compositions with improved thermal stability and catalytic activity as Zero-PGM (ZPGM) catalyst systems for DOC application are disclosed. Testing of YMn₂O₅ pseudo-brookite catalysts and YMnO₃ perovskite catalysts, including variations of calcination temperatures, are performed under DOC light-off (LO) tests at wide range of space velocity to evaluate catalytic performance, especially level of NO oxidation. The presence of YMn₂O₅ pseudo-brookite oxides in disclosed ZPGM catalyst compositions is analyzed by x-ray diffraction (XRD) analysis. XRD analyses and LO tests confirm that YMn₂O₅ pseudo-brookite catalysts exhibit higher catalytic activity and significant improved thermal stability when compared to conventional YMnO₃ perovskite catalysts.

### CROSS-REFERENCE TO RELATED APPLICATIONS

This application is a continuation-in-part of U.S. patent application Ser. No. 13/911,986, filed Jun. 6, 2013, which is hereby incorporated by reference.

### BACKGROUND

1. Field of the Disclosure

This disclosure relates generally to a new family of catalyst materials for diesel oxidation catalyst (DOC) systems completely or substantially free of Platinum Group Metals (PGM), with improved light-off performance and catalytic activity.

2. Background Information

Diesel engines offer superior fuel efficiency and greenhouse gas reduction potential. However, one of the technical obstacles to their broad implementation is the requirement for a lean nitrogen oxide (NO_{X}) exhaust system. Conventional lean NO_{X} exhaust systems are expensive to manufacture and are key contributors to the premium pricing associated with diesel engine equipped vehicles. Unlike a conventional gasoline engine exhaust in which equal amounts of oxidants (O₂ and NO_{X}) and reductants (CO, H₂, and hydrocarbons) are available, diesel engine exhaust contains excessive O₂ due to combustion occurring at much higher air-to-fuel ratios (>20). This oxygen-rich environment makes the removal of NOₓ much more difficult.

Conventional diesel exhaust systems employ diesel oxidation catalyst (DOC) technology and are referred to as diesel oxidation catalyst (DOC) systems. Typically, DOC systems include a substrate structure upon which promoting oxides are deposited. Bimetallic catalysts, based on platinum group metals (PGM), are then deposited upon the promoting oxides.

Although PGM catalyst materials are effective for toxic emission control and have been commercialized by the emissions control industry, PGM materials are scarce and expensive. This high cost remains a critical factor for wide spread applications of these catalyst materials. Therefore, there is a need to provide a lower cost DOC system exhibiting catalytic properties substantially similar to or better than the catalytic properties exhibited by DOC systems employing PGM catalyst materials.

### SUMMARY

The present disclosure describes pseudo-brookite catalyst materials implemented within Zero-PGM (ZPGM) catalyst systems for use in diesel oxidation catalyst (DOC) applications.

In some embodiments, the ZPGM pseudo-brookite catalysts expressed with a general formula of AB₂O₅ exhibit higher stability and catalytic activity when compared to conventional perovskite catalysts expressed with a general formula of ABO₃.

In other embodiments, bulk powder YMn₂O₅ pseudo-brookite and bulk powder YMn₂O₅ pseudo-brookite deposited onto suitable support oxide powder are produced by employing conventional synthesis methods. Test results of bulk powder YMn₂O₅ pseudo-brookite are compared to test results of bulk powder YMnO₃ perovskite to compare catalytic performance and stability.

In some embodiments, x-ray diffraction (XRD) analyses are used to analyze/measure formation of both YMnO₃ perovskite phases and YMn₂O₅ pseudo-brookite phases. In these embodiments, XRD data is then analyzed to determine if the structures of the YMnO₃ perovskite and YMn₂O₅ pseudo-brookite remain stable. If the structures of the YMnO₃ perovskite or YMn₂O₅ pseudo-brookite become unstable, new phases will form within the ZPGM catalyst material. Further to these embodiments, different calcination temperatures will result in different YMnO₃ perovskite and YMn₂O₅ pseudo-brookite phases. In some embodiments, XRD phase stability analyses confirm that YMn₂O₅ pseudo-brookite phase is stable at calcination temperatures from about 800° C. to about 1000° C.

In other embodiments, the disclosed ZPGM catalyst compositions are subjected to DOC standard light-off (LO) tests to assess/verify NO oxidation activity and stability. In these embodiments, DOC LO tests are performed on YMnO₃ perovskite catalyst compositions and YMn₂O₅ pseudo-brookite catalyst compositions by employing a flow reactor at a space velocity (SV) of about 54,000 h⁻¹ and about 100,000 h⁻¹.

In some embodiments, results of the XRD analyses and LO tests indicate pseudo-brookite catalyst compositions can be employed within ZPGM catalyst systems as a replacement for perovskite catalyst compositions in DOC applications. In these embodiments, the use of the pseudo-brookite catalyst compositions results in high catalytic performance, especially for NO oxidation activity. Further to these embodiments, ZPGM YMn₂O₅ pseudo-brookite catalyst compositions exhibit higher catalytic activity when compared to ZPGM perovskite catalyst compositions.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 is a graphical representation illustrating an x-ray diffraction (XRD) phase stability analysis of YMnO₃ perovskite and YMn₂O₅ pseudo-brookite bulk powder samples and calcined at about 800° C., according to an embodiment.

FIG. 2 is a graphical representation illustrating an XRD phase stability analysis of YMnO₃ perovskite and YMn₂O₅ pseudo-brookite bulk powder samples and calcined at about 1000° C., according to an embodiment.

FIG. 3 is a graphical representation illustrating multiple XRD phase stability analyses of YMn₂O₅ pseudo-brookite bulk powder samples and YMn₂O₅ pseudo-brookite supported on doped zirconia samples, both calcined at about 800° C., according to an embodiment.

FIG. 4 is a graphical representation illustrating DOC light off (LO) test results of NO, HC, and CO gas pollutants conversion associated with YMn₂O₅ pseudo-brookite bulk powder samples calcined at about 800° C., according to an embodiment.

FIG. 5 is a graphical representation illustrating a comparison of the results of DOC LO tests of NO conversion associated with both YMn₂O₅ pseudo-brookite and YMnO₃ perovskite bulk powder samples calcined at about 1000° C., according to an embodiment.

FIG. 6 is a graphical representation illustrating a comparison of the results of DOC LO tests of NO conversion associated with both YMn₂O₅ pseudo-brookite and YMnO₃ perovskite each supported on doped zirconia samples and calcined at about 800° C., according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms have the following definitions:

“Calcination” refers to a thermal treatment process applied to solid materials, in presence of air, to bring about a thermal decomposition, phase transition, or removal of a volatile fraction at temperatures below the melting point of the solid materials.

“Catalyst” refers to one or more materials that may be of use in the conversion of one or more other materials.

“Conversion” refers to the chemical alteration of at least one material into one or more other materials.

“Diesel oxidation catalyst (DOC)” refers to a device that utilizes a chemical process in order to break down pollutants within the exhaust stream of a diesel engine, turning them into less harmful components.

“Incipient wetness (IW)” refers to the process of adding solution of catalytic material to a dry support oxide powder until all pore volume of support oxide is filled out with solution and mixture goes slightly near saturation point.

“Perovskite” refers to a ZPGM catalyst, having ABO₃ structure of material which may be formed by partially substituting element “A” and “B” base metals with suitable non-platinum group metals.

“Pseudo-brookite” refers to a ZPGM catalyst, having AB₂O₅ structure of material which may be formed by partially substituting element “A” and “B” base metals with suitable non-platinum group metals.

“Support oxide” refers to porous solid oxides, typically mixed metal oxides that are used to provide a high surface area which aids in oxygen distribution and exposure of catalysts to reactants, such as, NO_{R}, CO, and hydrocarbons, among others.

“X-ray diffraction (XRD) analysis” refers to a rapid analytical technique for determining crystalline material structures, including atomic arrangement, crystalline size, and imperfections in order to identify unknown crystalline materials (e.g. minerals, inorganic compounds).

“Zero platinum group metal (ZPGM) catalyst” refers to a catalyst completely or substantially free of platinum group metals.

### Description of the Drawings

The present disclosure describes Zero-PGM (ZPGM) catalyst materials with pseudo-brookite composition for diesel oxidation catalyst (DOC) applications.

In some embodiments, pseudo-brookite catalysts are produced by applying the general formulation of AB₂O₅, where both A and B sites are implemented as cations and the A and B sites can be interchangeable. Example materials that are suitable to form pseudo-brookite catalysts include, but are not limited to, silver (Ag), manganese (Mn), yttrium (Y), lanthanum (La), cerium (Ce), iron (Fe), praseodymium (Pr), neodymium (Nd), strontium (Sr), cadmium (Cd), cobalt (Co), scandium (Sc), copper (Cu), niobium (Nb), and tungsten (W).

In other embodiments, prepared pseudo-brookite catalysts include yttrium (Y) with an example formula of YMn₂O₅. In these embodiments, Y—Mn pseudo-brookite bulk powder and Y—Mn pseudo-brookite deposited on support oxide powders are employed in the preparation of catalyst coatings for ZPGM catalyst systems.

In some embodiments, in order to compare the performance of the disclosed Y—Mn pseudo-brookite catalysts with Y—Mn perovskite catalysts, the present disclosure includes the preparation of perovskite catalysts with the general formulation of ABO₃. Examples of the preparation of perovskite catalysts are disclosed in U.S. patent application Ser. No. 13/911,986. In these embodiments, cation combinations are formed with a general formula of ABO₃, where both A and B sites are implemented as cations and the A and B sites can be interchangeable. Example materials that are suitable to form perovskite catalysts include, but are not limited to, silver (Ag), manganese (Mn), yttrium (Y), lanthanum (La), cerium (Ce), iron (Fe), praseodymium (Pr), neodymium (Nd), strontium (Sr), cadmium (Cd), cobalt (Co), scandium (Sc), copper (Cu), niobium (Nb), and tungsten (W).

Further to these embodiments, prepared perovskite catalysts include yttrium (Y) with an example formula of YMnO₃. In these embodiments, Y—Mn perovskite bulk powder and Y—Mn perovskite deposited on support oxide powders are employed in the preparation of catalyst coatings for ZPGM catalyst systems.

In some embodiments, support oxides that are suitable for ZPGM perovskites and pseudo-brookites include, but are not limited to ZrO₂, doped ZrO₂, Al₂O₃, doped Al₂O₃, SiO₂, TiO₂, Nb₂O₅, or combinations thereof. In these embodiments, suitable support oxide that is combined with Y—Mn perovskite or Y—Mn pseudo-brookite catalysts is doped zirconia (ZrO₂-10%Pr₆O₁₁).

Bulk powder ZPGM catalyst material composition and preparation

In some embodiments, bulk powder Y—Mn pseudo-brookite and Y—Mn perovskite are produced using a nitrate combustion method. In these embodiments, the preparation begins by mixing the appropriate amount of Y nitrate solution and Mn nitrate solution with water to produce an Y—Mn solution at an appropriate molar ratio (Y:Mn), where Y:Mn molar ratio is about 1:1 for YMnO₃ perovskite or about 1:2 for YMn₂O₅ pseudo-brookite. Further to these embodiments, the Y—Mn solution is then fired from about 300° C. to about 400° C. for nitrate combustion. In these embodiments, the firing produces Y—Mn solid material. Further to these embodiments, the Y—Mn solid material is ground and calcined at a range of temperatures from about 800° C. to about 1000° C., for about 5 hours. In these embodiments, the grinding and calcination produces Y—Mn powder. The calcined Y—Mn powder is then re-ground to fine grain powder of YMnO₃ perovskite or YMn₂O₅ pseudo-brookite, depending on the original molar ratio used.

In some embodiments, incipient wetness (IW) methodology is used for preparation of Y—Mn pseudo-brookite and Y—Mn perovskite supported on doped zirconia. In these embodiments, the preparation begins by mixing the appropriate amount of Y nitrate solution and Mn nitrate solution with water to produce Y—Mn solution at an appropriate molar ratio (Y:Mn), where Y:Mn molar ratio is about 1:1 for YMnO₃ perovskite, and about 1:2 for YMn₂O₅ pseudo-brookite. Further to these embodiments, the Y—Mn solution is then added drop-wise to the doped zirconia according to the IW methodology. In these embodiments, the mixture of YMnO₃ perovskite or YMn₂O₅ pseudo-brookite with the selected support oxide powders is dried at about 120° C., and then calcined at a plurality of temperatures within a range from about 800° C. to about 1000° C. for about 5 hours.

In order to determine phase formation and thermal stability of the disclosed ZPGM catalyst compositions, X-ray diffraction (XRD) analyses are performed. X-ray diffraction analysis

In some embodiments, x-ray diffraction (XRD) analyses are used to analyze/measure the formation as well as the stability of YMnO₃ perovskite and YMn₂O₅ pseudo-brookite phases. In these embodiments, the XRD data is then analyzed to determine if the structures of the YMnO₃ perovskite and YMn₂O₅ pseudo-brookite remain stable. If the structures of the YMnO₃ perovskite or YMn₂O₅ pseudo-brookite become unstable, new phases will form within the ZPGM catalyst material. Further to these embodiments, different calcination temperatures will result in different YMnO₃ perovskite and YMn₂O₅ pseudo-brookite phases.

In other embodiments, the XRD phase stability analyses are performed on YMnO₃ perovskite supported on doped zirconia powder samples, and on YMn₂O₅ pseudo-brookite supported on doped zirconia powder samples, where both powder samples are calcined at a range of temperatures from about 800° C. to about 1000° C., for about 5 hours.

In some embodiments, XRD patterns are measured on a powder diffractometer using Cu Ka radiation in the 2-theta range of about 15°-100° with a step size of about 0.02° and a dwell time of about 1 second. In these embodiments, the tube voltage and current are set to about 40 kV and about 30 mA, respectively. The resulting diffraction patterns are analyzed using the International Center for Diffraction Data (ICDD) database to identify phase formation. Examples of powder diffractometer include the MiniFlex™ powder diffractometer available from Rigaku® of Woodlands, Tex.

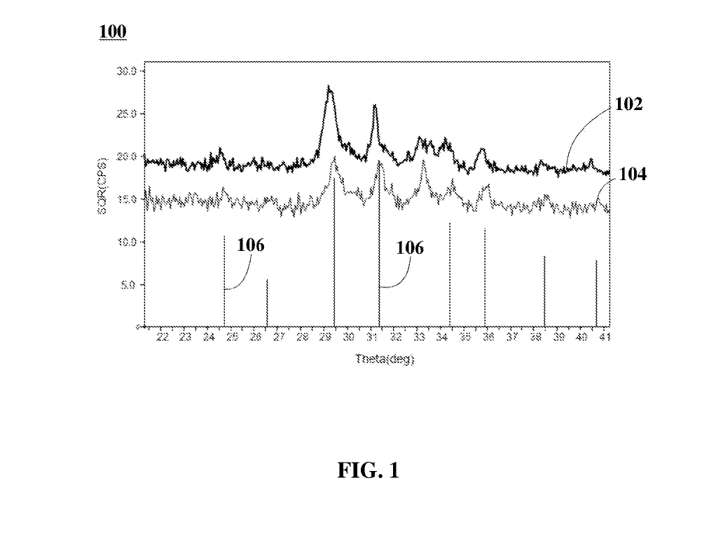

FIG. 1 is a graphical representation illustrating an x-ray diffraction (XRD) phase stability analysis of YMnO₃ perovskite and YMn₂O₅ pseudo-brookite bulk powder samples and calcined at about 800 ° C., according to an embodiment.

In FIG. 1, XRD analysis 100 includes XRD spectrum 102, XRD spectrum 104, and phase lines 106. In some embodiments, XRD spectrum 102 illustrates bulk powder YMnO₃ perovskite spectrum, XRD spectrum 104 illustrates bulk powder YMn₂O₅ pseudo-brookite spectrum, and phase lines 106 illustrate YMn₂O₅ pseudo-brookite phase. In these embodiments, after calcination the YMn₂O₅ pseudo-brookite phases arranged in an orthorhombic structure are produced as illustrated by phase lines 106. Therefore, the YMn₂O₅ pseudo-brookite catalyst compositions are stable. In other embodiments, after calcination, the associated YMnO₃ perovskite phase is not present in YMnO₃ perovskite bulk powder samples. Therefore, YMnO₃ perovskite catalyst compositions are not formed at a calcination temperature of about 800 ° C. with nitrate combustion method.

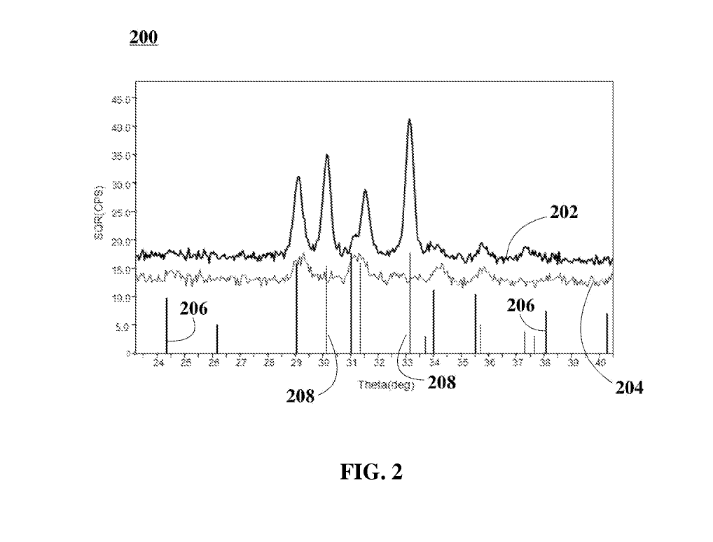

FIG. 2 is a graphical representation illustrating an XRD phase stability analysis of YMnO₃ perovskite and YMn₂O₅ pseudo-brookite bulk powder samples and calcined at about 1000° C., according to an embodiment.

In FIG. 2 XRD analysis 200 includes XRD spectrum 202, XRD spectrum 204, phase lines 206, and phase lines 208. In some embodiments, XRD spectrum 202 illustrates bulk powder YMnO₃ perovskite, XRD spectrum 204 illustrates bulk powder YMn₂O₅ pseudo-brookite, phase lines 206 illustrate YMn₂O₅ pseudo-brookite phases, and phase lines 208 illustrate YMnO₃ perovskite phase. In these embodiments, after calcination the YMn₂O₅ pseudo-brookite phase remains present in the bulk powderYMn₂O₅ pseudo-brookite. Further to these embodiments, the YMnO₃ perovskite phase remains extensively present in YMnO₃ perovskite bulk powder samples.

XRD analysis 100 and XRD analysis 200 illustrate that YMn₂O₅ pseudo-brookite compositions form more readily when using nitrate combustion methodology at about 800° C. Further, YMn₂O₅ pseudo-brookite compositions are stable when using nitrate combustion methodology at a high calcination temperature of about 1000° C. Moreover, YMnO₃ perovskite compositions are not easily formed with nitrate combustion method at low calcination temperatures, such as at about 800° C. YMnO₃ perovskite phase formed extensively at higher calcination temperatures, such as, at about 1000° C.

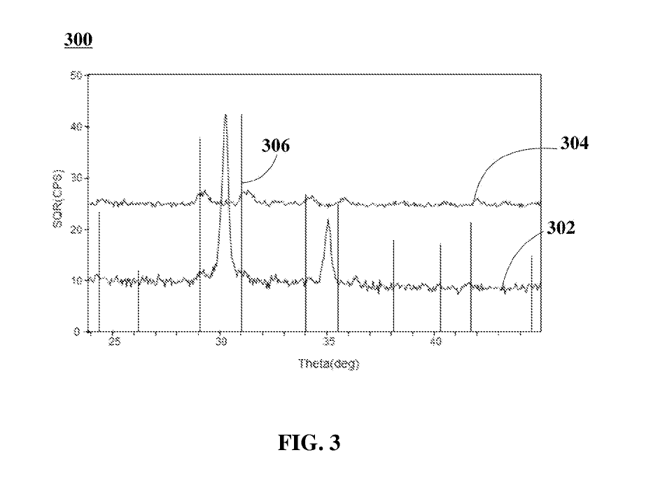

FIG. 3 is a graphical representation illustrating multiple XRD phase stability analyses of YMn₂O₅ pseudo-brookite bulk powder samples and YMn₂O₅ pseudo-brookite supported on doped zirconia samples, both calcined at about 800° C., according to an embodiment.

In FIG. 3 XRD analysis 300 illustrates XRD spectrum 302, XRD spectrum 304, and phase lines 306. In some embodiments, XRD spectrum 302 illustrates YMn₂O₅ pseudo-brookite deposited on doped zirconia support oxide powder, XRD spectrum 304 illustrates bulk powderYMn₂O₅ pseudo-brookite, and phase lines 306 illustrate YMn₂O₅ pseudo-brookite phase. In these embodiments, after calcination the YMn₂O₅ pseudo-brookite phase remains present on the YMn₂O₅ pseudo-brookite supported on the doped zirconia. Further to these embodiments, the YMn₂O₅ pseudo-brookite phase is stable when deposited onto doped zirconia using IW methodology. Furthermore, the unassigned ZrO₂ diffraction peaks within XRD analysis 300 correspond to a ZrO₂ phase produced from the support oxide.

In some embodiments, the disclosed ZPGM catalyst compositions are subjected to DOC standard light-off (LO) tests to assess/verify catalytic activity.

DOC standard light-off test

In some embodiments, the DOC standard light-off (LO) test methodology is applied to YMn₂O₅ pseudo-brookite, YMnO₃ perovskite, and YMn₂O₅ pseudo-brookite and YMnO₃ perovskite systems deposited on doped zirconia support oxide. In these embodiments, the LO test is performed employing a flow reactor in which temperature is increased from about 75° C. to about 400° C. at a rate of about 40° C./min to measure the CO, HC and NO conversions. Further to these embodiments, a gas feed employed for the test includes a composition of about 100 ppm of NOₓ, 1,500 ppm of CO, about 4% of CO₂, about 4% of H₂O, about 14% of O₂, and about 430 ppm of C₃H₆, and a space velocity (SV) of about 54,000 h⁻¹ or about 100,000 h⁻¹. In these embodiments, during DOC LO test, neither N₂O nor NH₃ are formed.

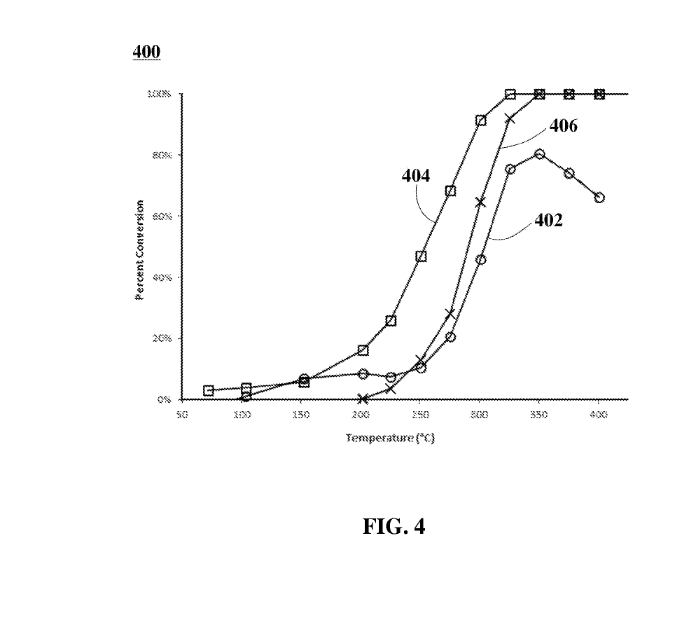

FIG. 4 is a graphical representation illustrating DOC light off (LO) test results of NO, HC, and CO gas pollutants conversion associated with YMn₂O₅ pseudo-brookite bulk powder samples calcined at about 800° C., according to an embodiment. In this embodiment, a standard DOC gas stream composition is used within the DOC LO test methodology at a space velocity (SV) of about 54,000 h⁻¹.

As observed in previous XRD spectrums (FIGS. 1 and 3), in catalyst samples prepared at Y:Mn molar ratio of about 1:2 and calcination temperature of about 800° C., only the pseudo-brookite phase is present.

In FIG. 4, DOC LO test 400 results include conversion curve 402 (solid line with circles), conversion curve 404 (solid line with squares), and conversion curve 406 (solid line with crosses), which illustrate NO conversion, CO conversion, and HC conversion, respectively. In FIG. 4, the T50 point for NO, CO, and HC occurs at temperatures of about 305° C., 255° C., and 290° C., respectively.

Results from DOC LO test 400 illustrate that YMn₂O₅ pseudo-brookite bulk powder samples exhibit high oxidation catalytic activity, which oxidizes NO up to about 80% at a temperature of about 350° C. Furthermore, YMn₂O₅ pseudo-brookite bulk powder samples exhibit significantly high CO conversion and HC conversion activities at a temperature of about 350° C. as well. Therefore, YMn₂O₅ pseudo-brookite catalyst compositions exhibit significant high NO, CO, and HC catalytic activities for DOC application.

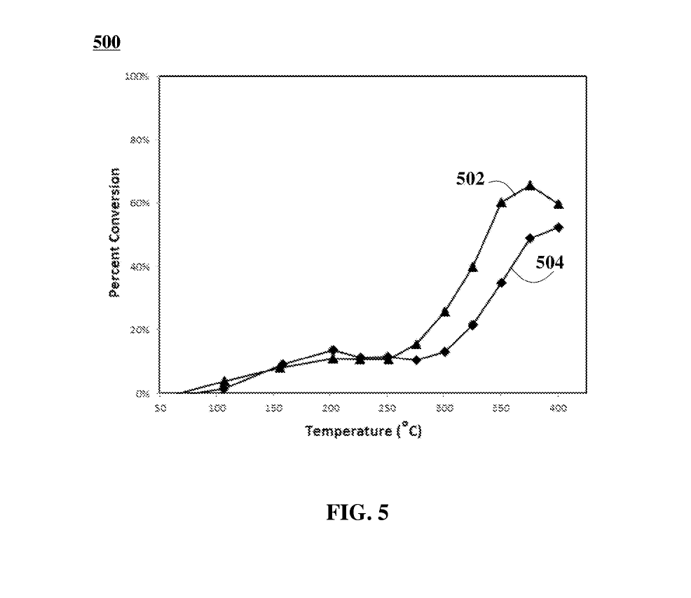

FIG. 5 is a graphical representation illustrating a comparison of the results of DOC LO tests of NO conversion associated with both YMn₂O₅ pseudo-brookite and YMnO₃ perovskite bulk powder samples calcined at about 1000° C., according to an embodiment. In this embodiment, a standard DOC gas stream composition is used within the DOC LO test methodology at a SV of about 54,000 h⁻¹.

In FIG. 5, DOC LO test 500 results include conversion curve 502 (solid line with triangles) and conversion curve 504 (solid line with squares), which illustrate NO conversion of YMn₂O₅ pseudo-brookite bulk powder samples and YMnO₃ perovskite bulk powder samples, respectively. In some embodiments, the YMn₂O₅ pseudo-brookite bulk powder samples exhibit a NO conversion of about 66% at a temperature of about 375° C., while the YMnO₃ perovskite bulk powder samples exhibit a NO conversion of about 52% at a temperature of about 401° C. In these embodiments, DOC LO test 500 results indicate the YMn₂O₅ pseudo-brookite compositions exhibit higher NO oxidation activity when compared to the NO oxidation activity for the YMnO₃ perovskite compositions.

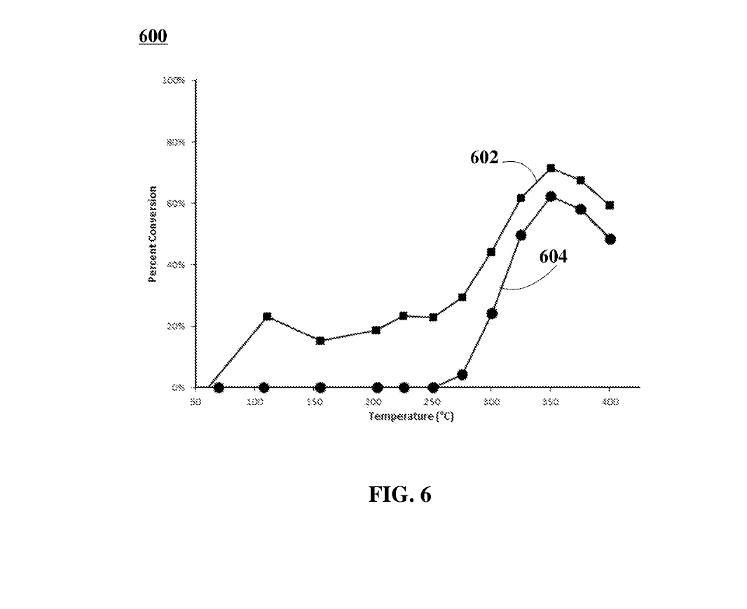

FIG. 6 is a graphical representation illustrating a comparison of the results of DOC LO tests of NO conversion associated with both YMn₂O₅ pseudo-brookite and YMnO₃ perovskite each supported on doped zirconia samples and calcined at about 800° C., according to an embodiment. In this embodiment, a standard DOC gas stream composition is used within the DOC LO test methodology at a SV of about 100,000 h⁻¹.

In FIG. 6, DOC LO test 600 results include conversion curve 602 (solid line with squares) and conversion curve 604 (solid line with circles), which illustrate NO conversion of YMn₂O₅ pseudo-brookite and YMnO₃ perovskite each supported on doped zirconia powder samples, respectively. In some embodiments, the YMn₂O₅ pseudo-brookite supported on doped zirconia powder samples exhibit a NO conversion of about 71.4% at a temperature of about 350° C., while the YMnO₃ perovskite bulk powder samples exhibit a NO conversion of about 62% at a temperature of about 350° C. In these embodiments, DOC LO test 500 results indicate the YMn₂O₅ pseudo-brookite compositions exhibit higher NO oxidation activity when compared to the YMnO₃ perovskite compositions. These results confirm NO oxidation activity for YMn₂O₅ pseudo-brookite supported on doped zirconia samples is higher than NO oxidation activity for YMnO₃ perovskite supported on doped zirconia samples, verifying that at high SV, such as, 100,000 h⁻¹, pseudo-brookite compositions exhibit lower light off temperature.

As illustrated in FIG. 6, NO oxidation using the YMn₂O₅ pseudo-brookite supported on doped zirconia powder samples begins at low temperature, such as 100° C., and NO oxidation activity increases when compared to the NO oxidation activity using YMnO₃ perovskite supported on doped zirconia powder samples.

Further, DOC LO test 500 and DOC LO test 600 results indicate the YMn₂O₅ pseudo-brookite catalyst compositions exhibit higher NO oxidation activity at a high space velocity and at a high thermal treatment when compared to the NO oxidation activity for YMnO₃ perovskite catalyst compositions at the same SV and thermal treatment conditions.

Results from XRD analyses and LO tests confirm that pseudo-brookite catalyst compositions, especially YMn₂O₅ pseudo-brookite bulk powder, can be employed in ZPGM catalysts systems for DOC applications, with high catalytic performance, especially for NO oxidation activity. In these embodiments, the disclosed ZPGM YMn₂O₅ pseudo-brookite catalyst compositions are thermally stable and exhibit higher catalytic activity when compared to YMnO₃ perovskite catalyst compositions over a wide range of space velocities.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A catalyst composition comprising a pseudo-brookite structured compound of general formula AB₂O₅, wherein A is a cation selected from the group consisting of silver (Ag), manganese (Mn), yttrium (Y), lanthanum (La), cerium (Ce), iron (Fe), praseodymium (Pr), neodymium (Nd), strontium (Sr), cadmium (Cd), cobalt (Co), scandium (Sc), copper (Cu), niobium (Nb), and tungsten (W), and wherein B is a cation selected from the group consisting of Ag, Mn, Y, La, Ce, Fe, Pr, Nd, Sr, Cd, Co, Sc, Cu, Nb, and W.

2. The catalyst composition of claim 1, wherein A is Y.

3. The catalyst composition of claim 2, wherein B is Mn.

4. The catalyst composition of claim 1, further comprising at least one support oxide selected from the group consisting of ZrO₂, doped ZrO₂, Al₂O₃, doped Al₂O₃, SiO₂, TiO₂, and Nb₂O₅.

5. The catalyst composition of claim 4, wherein the at least one support oxide includes Pr doped ZrO₂ of formula ZrO₂—Pr₆O₁₁.

6. The catalyst composition of claim 5, wherein the Pr doped ZrO₂ comprises about 10% by weight Pr₆O₁₁.

7. The catalyst composition of claim 3, further comprising at least one support oxide selected from the group consisting of ZrO₂, doped ZrO₂, Al₂O₃, doped Al₂O₃, SiO₂, TiO₂, and Nb₂O₅.

8. The catalyst composition of claim 7, wherein the at least one support oxide includes Pr doped ZrO₂ of formula ZrO₂—Pr₆O₁₁.

9. The catalyst composition of claim 8, wherein the Pr doped ZrO₂ comprises about 10% by weight Pr₆O₁₁.

10. The catalyst composition of claim 3, wherein the catalyst composition is calcined at a temperature from about 800° C. to about 1000° C.

11. A method of manufacturing a catalyst composition comprising, mixing a first solution including nitrate and a cation A, a second solution including nitrate and a cation B, and water to form a first mixture, wherein the molar ratio of cation B to cation A is about 2 moles of cation B to about 1 mole of cation A,
firing the first mixture at a nitrate combustion temperature to form a fired mixture, and
calcining at a calcining temperature for a calcining period,
wherein the catalyst composition is a pseudo-brookite structured compound of general formula AB₂O₅, wherein cation A is selected from the group consisting of Ag, Mn, Y, La, Ce, Fe, Pr, Nd, Sr, Cd, Co, Sc, Cu, Nb, and W, and wherein cation B is selected from the group consisting of Ag, Mn, Y, La, Ce, Fe, Pr, Nd, Sr, Cd, Co, Sc, Cu, Nb, and W.

12. The method of manufacturing the catalyst composition of claim 11, wherein the nitrate combustion temperature is about 300° C. to about 400° C.

13. The method of manufacturing the catalyst composition of claim 11, wherein the calcining temperature is about 800° C. to about 1000° C.

14. The method of manufacturing the catalyst composition of claim 11, wherein the calcining period is about 5 hours.

15. The method of manufacturing the catalyst composition of claim 11, further comprising drying the fired mixture at a drying temperature, wherein the drying temperature is about 120° C.

16. The method of manufacturing the catalyst composition of claim 11, wherein cation A is Y.

17. The method of manufacturing the catalyst composition of claim 16, wherein cation B is Mn.

18. The method of manufacturing the catalyst composition of claim 11, further comprising grinding the fired mixture to form a first powder prior to calcining at the calcining temperature for the calcining period.

19. The method of manufacturing the catalyst composition of claim 11, further comprising adding the fired mixture drop-wise to a doped zirconia according to incipient wetness methodology to form a catalyst solution.

20. The method of manufacturing the catalyst composition of claim 19, further comprising drying the catalyst solution at a drying temperature, wherein the drying temperature is about 120° C., prior to calcining at about 800° C. to about 1000° C.
